(19) United States
(12) Patent Application Publication
(10) Pub. No.: US 2015/0269905 A1
(43) Pub. Date: Sep. 24, 2015

(54) Display Method and Display System

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Zhaohui MENG, Beijing (CN); Renwei GUO, Beijing (CN); Yang CHEN, Beijing (CN); Duo ZHANG, Beijing (CN)

(21) Appl. No.: 14/500,211

(22) Filed: Sep. 29, 2014

(30) Foreign Application Priority Data
Mar. 21, 2014 (CN) 201410109291.8

(51) Int. Cl. G09G 5/02

(52) U.S. Cl. CPC G09G 5/02

(57) ABSTRACT

The present invention provides a display method and a display system. The display method comprises: receiving input RGB signals, converting the RGB signals into CMYK signals, and converting a K signal in the CMYK signals into a W signal, so as to obtain RGBW signals comprising the input RGB signals and the W signal. According to the display method, the RGB signals can be converted into the RGBW signals, thus the display brightness of the image is greatly improved, no colour loss of the RGB signals in the RGBW signals can be guaranteed after the signal conversion, and then the display quality and the display effect of the image are greatly improved. The display system is capable of realizing the beneficial effect above as well by providing the conversion module.

### FIELD OF THE INVENTION

The present invention relates to the field of display technology, and particularly relates to a display method and a display system.

### BACKGROUND OF THE INVENTION

In recent years, with the continuous improvement of performances of display products, requirements on the display products are gradually developed to a direction of large screen and high resolution, and realization for low electricity consumption is also required.

As the traditional RGB (red, green and blue pixels) three-colour display technology is incapable of realizing high resolution and low electricity consumption simultaneously, an RGBW (red, green, blue and white pixels) four-colour display technology occurs. According to the RGBW display technology, a white pixel (W pixel) is added on the basis of the traditional RGB display technology, and therefore, improvement for the brightness of the display products is successfully realized.

After the white pixel is added, RGB three-colour display signals in the traditional RGB display technology need to be converted to RGBW four-colour display signals at first, so as to provide a drive signal for display for RGBW four-colour pixels.

At present, there are a plurality of conversion algorithms for converting the RGB three-colour display signals to the RGBW four-colour display signals, however, the conversion algorithms cause serious colour loss in the RGB display signals in the RGBW four-colour display signals, thus causing the loss of image quality of the display products, and influencing the display effects of the display products.

### SUMMARY OF THE INVENTION

The present invention provides a display method and a display system aiming at the technical problems above existing in the prior art. The display method is capable of converting RGB signals into RGBW signals, and guaranteeing no colour loss of the RGB signals in the RGBW signals after conversion, thus greatly reducing the colour loss during the display of the RGBW signals, and then greatly improving the display quality and the display effect of an image.

The present invention provides a display method, comprising: receiving input RGB signals, converting the RGB signals into CMYK (cyan, magenta, yellow and black) signals, and converting a K signal in the CMYK signals into a W signal, so as to obtain RGBW signals comprising the input RGB signals and the W signal.

Preferably, the converting the RGB signals into CMYK signals comprises: calculating according to the RGB signals to obtain CMY (cyan, magenta and yellow) medium signals, calculating according to the CMY medium signals to obtain a K medium signal which is the minimum value among grey scales of the CMY medium signals, and calculating according to the CMY medium signals and the K medium signal to obtain the CMYK signals.

Preferably, the converting a K signal in the CMYK signals into a W signal comprises reversing the K signal in the CMYK signals to obtain the W signal.

Preferably, the display method further comprises: determining whether the RGB signals are displayed or the RGB signals and the W signal are displayed simultaneously according to external environment brightness.

Preferably, the display method further comprises: detecting the external environment brightness, and when the external environment brightness is greater than a set value, converting the RGB signals to obtain the W signal, and displaying the RGB signals and the W signal simultaneously; and when the external environment brightness is less than or equal to the set value, displaying the RGB signals.

The present invention further provides a display system comprising an input module used for inputting RGB signals, wherein the display system further comprises: a conversion module electrically connected with the input module, and used for receiving the RGB signals, converting the RGB signals into CMYK signals, and converting a K signal in the CMYK signals into a W signal, so as to obtain RGBW signals comprising the input RGB signals and the W signal.

Preferably, the conversion module comprises a calculation sub-module and a reversion sub-module, the calculation sub-module is used for calculating according to the RGB signals to obtain CMY medium signals, calculating according to the CMY medium signals to obtain a K medium signal, and calculating according to the CMY medium signals and the K medium signal to obtain the CMYK signals, wherein the K medium signal is the minimum value among grey scales of the CMY medium signals; and the reversion sub-module is used for reversing the K signal in the CMYK signals to obtain the W signal.

Preferably, the display system further comprises RGB pixel units and W pixel units, the RGB pixel units are electrically connected with the input module, the W pixel units are electrically connected with the conversion module, the RGB pixel units are used for displaying the RGB signals, and the W pixel units are used for displaying the W signals.

Preferably, the display system further comprises a detection module and a control module, the detection module is electrically connected with the control module, the control module is electrically connected with the conversion module and the W pixel units, the detection module is used for detecting external environment brightness, the control module is used for controlling the turn-on and turn-off of the conversion module according to the detection result of the detection module, and the control module is further used for controlling the turn-on and turn-off of the W pixel units according to the detection result of the detection module.

Preferably, the detection module comprises a photoresistor.

The present invention has the following beneficial effects: according to the display method provided by the present invention, by converting the RGB signals into the CMYK signals, and then converting the K signal in the CMYK signals into the W signal, display may be carried out by the W signal obtained by conversion and the initial RGB signals, thus no colour loss of the RGB signals is guaranteed while the display brightness of the image is greatly improved; similarly, according to the display system provided by the present invention, by providing the conversion module, the RGB signals are converted into the CMYK signals at first, and then the K signal is converted to obtain the W signal, so as to finally obtain the RGBW signals comprising the W signal and the initial RGB signals, thus the display brightness of the image can be greatly improved, meanwhile, no colour loss of the RGB signals in the RGBW signals can be guaranteed after the signal conversion, and compared with the existing RGBW signal display, the display quality and the display effect of the image are greatly improved.

### BRIEF DESCRIPTION OF THE DRAWINGS

FIG. 1 is a flow diagram of a display method in embodiment I of the present invention;

FIG. 2 is a flow diagram of displaying through the display method in embodiment I of the present invention according to external environment brightness; and

FIG. 3 is a functional block diagram of a display system in embodiment II of the present invention.

### DETAILED DESCRIPTION OF THE EMBODIMENTS

In order to enable a person skilled in the art to understand the technical scheme of the present invention better, a display method and a display system provided by the present invention will be described in details below in combination with the accompanying drawings and specific implementations.

It should be noted that, in the embodiments below of the present invention, the RGB signals mean red, green and blue display signals, the CMYK signals mean cyan, magenta, yellow and black display signals, the CMY signals mean cyan, magenta and yellow display signals, the K signal means a black display signal, the RGBW signals mean red, green, blue and white display signals, and the W signal means a white display signal; the RGB pixel units mean red, green and blue pixel units, and the W pixel unit means a white pixel unit.

### Embodiment I

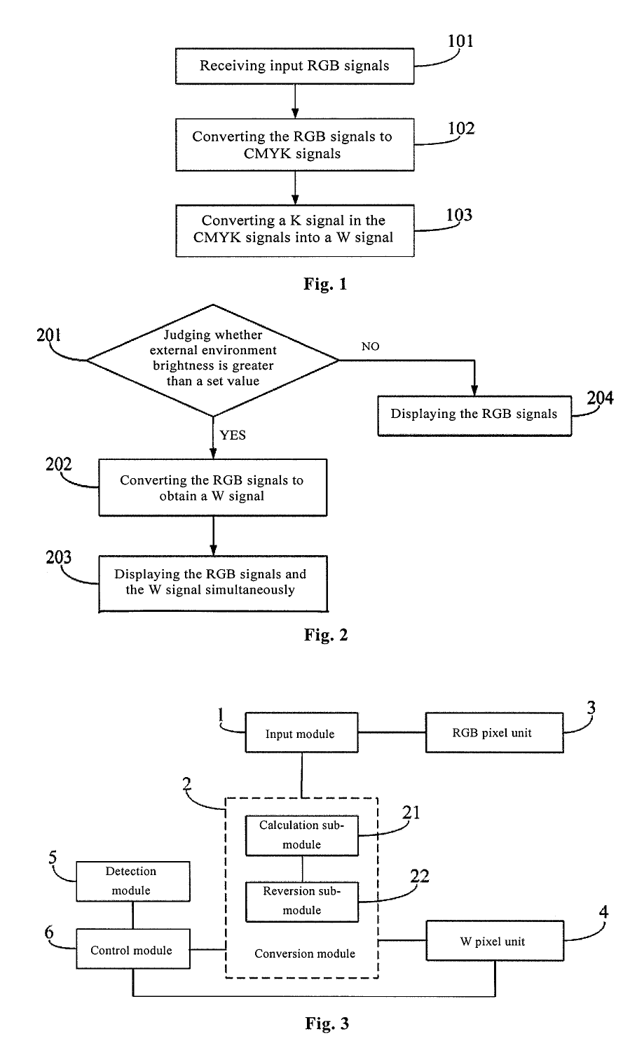

The embodiment provides a display method, as shown in FIG. 1, comprising:

step 101: receiving input RGB signals.

Step 102: converting the RGB signals into CMYK signals.

The step specifically comprises: calculating according to the RGB signals to obtain CMY medium signals, calculating according to the CMY medium signals to obtain a K medium signal which is the minimum value among grey scales of the CMY medium signals, and calculating according to the CMY medium signals and the K medium signal to obtain the CMYK signals.

Step 103: converting the K signal in the CMYK signals into a W signal.

In the step, the K signal in the CMYK signals is reversed to obtain the W signal. It needs to be noted that, the grey scale of the W signal is synchronously determined while the W signal is obtained by the step above.

For example, the conversion for the RGB signals into the RGBW signals is realized by the following program statement:

| | |
|---|---|
| L1 | //RGB —> CMYK |
| L2 | //RGB values from 0 to 255 |
| L3 | //CMY results from 0 to 1 |
| L4 | C = 1 - (R/255) |
| L5 | M = 1 - (G/255) |
| L6 | Y = 1 - (B/255) |
| L7 | //CMYK and CMY values from 0 to 1 |
| L8 | var_K = 1 |
| L9 | if (C < var_K) var_K = C |
| L10 | if (M < var_K) var_K = M |
| L11 | if (Y < var_K) var_K = Y |
| L12 | if (var_K == 1) {//Black |

| | |
|---|---|
| L13 | C = 0 |
| L14 | M = 0 |
| L15 | Y = 0 |

| | |
|---|---|
| L16 | } |
| L17 | K = var_K |
| L18 | // R, G, B(RGBW)=R, G, B(RGB) |
| L19 | W = ~K //W is obtained by reversing K, W values from 0 to 100 |

wherein the values of all of the R, G and B signals are in the range of 0-255, and values of 0-255 represent the different grey scales of the R, G and B signals respectively, whereas the value of the W signal is in the range of 0-100. The conversion of the RGB signals into the CMY signals is finished by statement L2 to statement L6, and the conversion process is free from colour loss. The conversion of CMY signals into the CMYK signals is finished by statement L7 to statement L17, the conversion of K signal into the W signal is finished by statement L19, and the RGB signals keep no colour loss in the two conversion processes, whereas the W signal reserves the grey scales in the range of 0-100 and loses grey scales in the range of 100-255.

In the prior art, many methods for converting the RGB signal into the CMYK signals exist, and the specific algorithm adopted by the program above is illustrated herein: firstly, a group of R, G and B values (that is, the respective values of R, G and B signals) is input, calculation is carried out according to formulas c=1−R, m=1−G and y=1−B to obtain the medium values c, m and y of C, M and Y; and the medium value k of K is determined to be the minimum value of c, m and y according to an under colour removal function (UCR), that is, k=min[c,m,y]. Then the final C, M, Y and K values (that is, the values of C, M, Y and K signals) are obtained by calculating via the following formulas according to the medium values c, m, y and k, and incorporating the influences of a black generation function (BG) and the under colour removal function (UCR):

C=min{0,c−UCR(k)},

M=min{1.0,max(0.0,m−UCR(k))},

Y=min{1.0,max[0.0,y−UCR(k)]},

K=min{1.0,max[0.0,BG(k)]}.

According to the present invention, the K value is reversed to obtain the W value (that is, the value of the W signal). By virtue of the algorithm above, the W value is obtained, that is, the W signal of which the grey scale is determined is obtained. According to the present invention, the obtained W signal and the initially input RGB signals form the RGBW signals for display.

By virtue of the program and algorithm above, after the RGB signals are converted into the RGBW signals, no colour loss of the RGB signals in the RGBW signals can be guaranteed, thus greatly reducing the colour loss during the display of the RGBW signals, and then greatly improving the display quality and the display effect of the image.

The display method in the embodiment further comprises: determining whether the RGB signals are displayed or the RGB signals and the W signal are displayed simultaneously according to external environment brightness, that is, the display method is capable of carrying out switching selection between RGB three-colour display and RGBW four-colour display according to external environment brightness.

In this case, the specific switching selection process is as shown in FIG. 2, which comprises: step 201: detecting external environment brightness, that is, judging whether external environment brightness is greater than a set value or not. When the external environment brightness is greater than the set value, step 202 is executed: obtaining a W signal by converting the RGB signals; then step 203 is executed: displaying the RGB signals and the W signal simultaneously. When the external environment brightness is less than the set value, step 204 is executed: displaying the RGB signals. That is, display for the RGBW signals is carried out in a condition of high external environment brightness, and the display brightness of the image is improved due to display for the W signal; and the high display brightness of the image is not needed in a condition of low external environment brightness, then only the RGB signals are displayed. Due to the switching selection, display power consumption is greatly reduced, and the display quality and the display effect of the image are also improved simultaneously.

The embodiment has the beneficial effect: according to the display method in the embodiment, by converting the RGB signals into the CMYK signals, and then converting the K signal in the CMYK signals into the W signal, after the RGB signals are converted into the RGBW signals, no colour loss of the RGB signals in the RGBW signals can be guaranteed, thus greatly reducing the colour loss during the display of the RGBW signals, and then greatly improving the display quality and the display effect of an image.

### Embodiment II

The embodiment provides a display system, as shown in FIG. 3, comprising: an input module 1 used for inputting RGB signals, and further comprising a conversion module 2 electrically connected with the input module 1, and used for receiving the RGB signals, converting the RGB signals into CMYK signals, and converting a K signal in the CMYK signals into a W signal.

In this case, the conversion module 2 comprises a calculation sub-module 21 and a reversion sub-module 22, the calculation sub-module 21 is used for calculating according to the RGB signals to obtain CMY medium signals, calculating the minimum value among grey scales of the CMY medium signals and setting the minimum value to a K medium signal, and calculating according to the CMY medium signals and the K medium signal to obtain the CMYK signals; and the reversion sub-module 22 is used for reversing the K signal in the CMYK signals to obtain the W signal. It needs to be noted that, the grey scale of the W signal is synchronously determined during the conversion process.

Due to the provision of the conversion module 2, after the RGB signals are converted into the RGBW signals, no colour loss of the RGB signals in the RGBW signals can be guaranteed, thus greatly improving the display quality and the display effect of an image in comparison with an RGBW signal with colour loss in the prior art.

In the embodiment, the display system further comprises RGB pixel units 3 and W pixel units 4, the RGB pixel units 3 are electrically connected with the input module 1, the W pixel units 4 are electrically connected with the conversion module 2, the RGB pixel units 3 are used for displaying the RGB signals, and the W pixel unit 4 is used for displaying the W signal, wherein the W pixel unit 4 comprises a W pixel used for displaying the W signal and a thin film transistor (TFT) used for controlling the W signal to display. Similarly, the RGB pixel unit 3 comprises RGB pixels used for displaying the RGB signals and a thin film transistor used for controlling the RGB signals to display.

In the embodiment, the display system further comprises a detection module 5 and a control module 6, the detection module 5 is electrically connected with the control module 6, the control module 6 is electrically connected with the conversion module 2 and the W pixel units 4, the detection module 5 is used for detecting external environment brightness, the control module 6 is used for controlling the turn-on and turn-off of the conversion module 2 according to the detection result of the detection module 5, and the control module 6 is further used for controlling the turn-on and turn-off of the W pixel units 4 according to the detection result of the detection module 5. The control module 6 is used for controlling display or non-display for the W pixel by controlling the turn-on and turn-off of the thin film transistor in the pixel unit 4.

Due to the provision of the detection module 5 and the control module 6, the display power consumption of the display system is greatly reduced, and the display quality and the display effect of the display system are also improved simultaneously.

In the embodiment, the detection module 5 is realized by a photoresistor. The photoresistor is used for detecting external environment brightness and sending the detection result to the control module 6, and the control module 6 is used for controlling the turn-on and turn-off of the conversion module 2 and the turn-on and turn-off of the W pixel unit 4 according to the brightness. It needs to be noted that, after the conversion module 2 is turned on, the W signal of which the grey scale is determined can be obtained by converting the input RGB signals.

The embodiment has the beneficial effect that: according to the display system in the embodiment, by providing the conversion module, the RGB signals can be converted into the RGBW signals, thus the display brightness of the image is greatly improved, no colour loss of the RGB signals in the RGBW signals can be guaranteed after the signal conversion, and then the display quality and the display effect of the image are greatly improved.

It may be understood that, the foregoing implementations are merely specific implementations adopted for illustrating the principle of the present invention, but the protection scope of the present invention is not limited thereto. Any variations and improvements could be made by a person of ordinary skill in the art without departing from the spirit and essence disclosed in the present invention, but the variations and improvements are still considered to be within the protection scope of the present invention.

1. A display method, comprising:
receiving input RGB signals;
converting the RGB signals into CMYK signals; and
converting a K signal in the CMYK signals into a W signal, so as to obtain RGBW signals comprising the input RGB signals and the W signal.

2. The display method according to claim 1, wherein the step of converting the RGB signals into CMYK signals comprises:
calculating according to the RGB signals to obtain CMY medium signals;
calculating according to the CMY medium signals to obtain a K medium signal which is the minimum value among grey scales of the CMY medium signals; and
calculating according to the CMY medium signals and the K medium signal to obtain the CMYK signals.

3. The display method according to claim 2, wherein the step of converting a K signal in the CMYK signals into a W signal comprises reversing the K signal in the CMYK signals to obtain the W signal.

4. The display method according to claim 1, further comprising: determining whether the RGB signals are displayed or the RGB signals and the W signal are displayed simultaneously according to external environment brightness.

5. The display method according to claim 4, further comprising: detecting the external environment brightness, and when the external environment brightness is greater than a set value, converting the RGB signals to obtain the W signal, and displaying the RGB signals and the W signal simultaneously; and when the external environment brightness is less than or equal to the set value, displaying the RGB signals.

6. A display system, comprising an input module used for inputting RGB signals, and further comprising: a conversion module electrically connected with the input module, and used for receiving the RGB signals, converting the RGB signals into CMYK signals, and converting a K signal in the CMYK signals into a W signal, so as to obtain RGBW signals comprising the input RGB signals and the W signal.

7. The display system according to claim 6, wherein the conversion module comprises a calculation sub-module and a reversion sub-module, the calculation sub-module is used for calculating according to the RGB signals to obtain CMY medium signals, calculating according to the CMY medium signals to obtain a K medium signal, and calculating according to the CMY medium signals and the K medium signal to obtain the CMYK signals, wherein the K medium signal is the minimum value among grey scales of the CMY medium signals; and the reversion sub-module is used for reversing the K signal in the CMYK signals to obtain the W signal.

8. The display system according to claim 6, further comprising RGB pixel units and W pixel units, wherein the RGB pixel units are electrically connected with the input module, the W pixel units are electrically connected with the conversion module, the RGB pixel units are used for displaying the RGB signals, and the W pixel units are used for displaying the W signals.

9. The display system according to claim 8, further comprising a detection module and a control module, wherein the detection module is electrically connected with the control module, the control module is electrically connected with the conversion module and the W pixel units, the detection module is used for detecting external environment brightness, the control module is used for controlling the turn-on and turn-off of the conversion module according to the detection result of the detection module, and the control module is further used for controlling the turn-on and turn-off of the W pixel units according to the detection result of the detection module.

10. The display system according to claim 9, wherein the detection module comprises a photoresistor.
